(19) United States
(12) Patent Application Publication
(10) Pub. No.: US 2021/0132604 A1
(43) Pub. Date: May 6, 2021

(54) AUTONOMOUS PASSENGER VEHICLE SYSTEM

(71) Applicant: Carla R. Gillett, Sacramento, CA (US)

(72) Inventor: Carla R. Gillett, Sacramento, CA (US)

(73) Assignee: Carla R. Gillett, Sacramento, CA (US)

(21) Appl. No.: 17/145,342

(22) Filed: Jan. 10, 2021

Related U.S. Application Data
(63) Continuation-in-part of application No. 15/993,609, filed on May 31, 2018, now Pat. No. 10,890,921.

(51) Int. Cl. G05D 1/00; G01S 19/13; B60W 40/02; B60W 60/00; G01C 22/00; B60W 40/08; G01C 21/34

(52) U.S. Cl. CPC G05D 1/0016; G01S 19/13; B60W 40/02; B60W 60/0025; G01C 22/00; B60W 40/08; B60W 2420/54; B60W 60/005; G05D 1/0038; B60W 2420/42; B60W 2420/52; B60W 2540/227; B60W 2556/50; G01C 21/3492

(57) ABSTRACT

Disclosed is an autonomous passenger vehicle system including an autonomous vehicle having electronic motor apparatuses, a control network associated with control center driver operating the autonomous passenger vehicle remotely through computer programs involving a network component using a mobile communication system and receiving information related to driving instructions to autonomous work at a traffic situation from the network component.

A notice of issuance for a continuation in part of patent application in reference to application Ser. No. 15/993,609, filed May 31, 2018; title: “Robot and Drone Array”.

### FIELD

The present invention relates to autonomous vehicles, and relates to a control network and method of operating the same.

### BACKGROUND

Companies such as UBER, LIFT, GOOGLE, APPLE, AMAZON and ride-share related companies are expressing interest in utilizing fleets of passenger vehicles for hire to pick-up one or more passengers and drop-off one or more passengers at desired locations, as well as transport payloads along with passengers in the vehicles.

Nowadays common and autonomous vehicles widely used around the globe apply to personal use vehicles or to delivery private owned service vehicles. For example, these vehicles operate without considering a need for public use passenger vehicles considerate of a passenger's plan.

### SUMMARY

The present autonomous passenger vehicle system offers an autonomous passenger vehicle configured for accomplishing at least one function involving a passenger's plan, a control network plan, a service plan, or accomplishing a combination thereof. Respectively the autonomous passenger vehicle operates remotely by a control network systematically configured to control navigation with respect to an autonomous drive system configured for transport objectives indicative of driving to pick-up locations and drop-off locations.

### BRIEF DESCRIPTION OF THE DRAWINGS

FIG. 1 is a side view illustrating a configuration of an autonomous passenger vehicle 100 in accordance with exemplary embodiments of the present invention.

FIG. 2 is a flowchart illustrating an operation of the autonomous passenger vehicle system in accordance with exemplary embodiments of the present invention.

FIG. 3A is a flowchart illustrating an operation of the control network in accordance with exemplary embodiments of the present invention.

FIG. 3B illustrates a generic overview of logical modules in an embodiment in accordance with exemplary embodiments of the present invention.

FIG. 4 shows embodiments of an apparatus for a transportation vehicle and a transportation vehicle, embodiments of an apparatus for a network component and a network component, and an embodiment of a system in accordance with exemplary embodiments of the present invention.

FIG. 5 illustrates an exceptional traffic scenario in accordance with exemplary embodiments of the present invention.

FIG. 6 illustrates embodiments of a transportation vehicle and a network component in accordance with exemplary embodiments of the present invention.

FIG. 7 is a flowchart illustrating an operation of the control network acquisition network 600 in accordance with exemplary embodiments of the present invention.

FIG. 8. illustrates a generic overview of logical modules in accordance with exemplary embodiments of the present invention.

FIG. 9 illustrates embodiments of a transportation vehicle and a network component in accordance with exemplary embodiments of the present invention.

FIG. 10 shows another exceptional traffic scenario in accordance with exemplary embodiments of the present invention.

### DETAILED DESCRIPTION OF THE DRAWINGS

The present disclosure provides various modes of transportation which can operate with a system such as the present invention, the following elements can be applied to accommodate driving systems of electric vehicles. In operating environment the autonomous passenger vehicle system is configured for generating communication information and data and transmitting a command that controls at least one function of the autonomous passenger vehicle based on one of; a passenger's plan, a control network plan, a service plan or a combination thereof. For example, a service plan may involve one of rental services or delivery services. In various elements the autonomous passenger vehicle system 200 . . . may utilize a service plan may involve one of renting an autonomous passenger vehicle for delivering a payload to a preselected starting location established to pick-up order, and the autonomous passenger vehicle 100 may provide one or more storage compartments for transporting a delivery payload to a delivery location where a recipient will retrieve the payload from the one or more storage compartments, these and other services are detailed in the following embodiments.

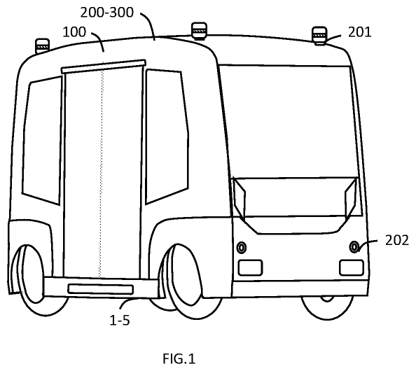

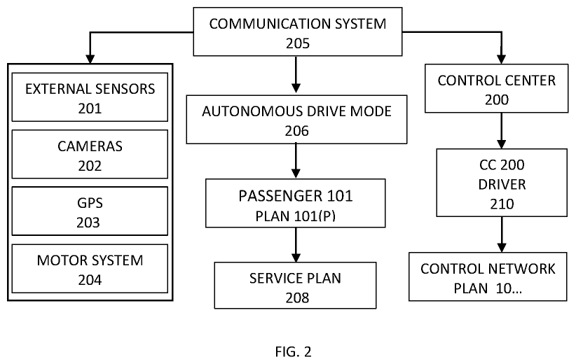

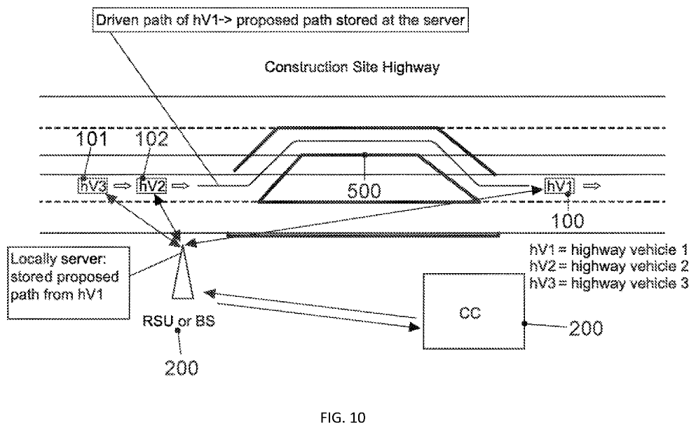

In greater detail FIG. 1 is an embodiment of the autonomous passenger vehicle system 200 providing a mode of transportation characterized as an autonomous passenger vehicle 100 having a frame 1 having a wheel-set 2 operably connected with a power source 3; a processing unit including a memory unit; a controller operable to receive and transmit signals to said processing unit, wherein said controller is operable to control said wheel-set; a wireless communication system electrically connected with said processing unit; a global positioning satellite receiver electrically connected with said processing unit; multiple seating 4 provided for supporting the passenger's 101, doors 5, and a control unit 209 linked to a combination of sensors involving LIDAR, radar, GPS and the like controlled by various systems, detailed in FIG. 2 and FIG. 10.

In greater detail FIG. 2 is a diagram of the autonomous passenger vehicle system 200 for controlling an autonomous passenger vehicle 100 operating with or without a passenger's onboard. Respectively the autonomous passenger vehicle 100 operates remotely 202 by a control network 300 to control driving states such as steering 203 and propulsion 204 associated with a navigation system 205. is systematically linked via the control unit 209 to a sensor system which receives data signals from various sensors monitoring driving states 203, 204 of the autonomous passenger vehicle 100.

The autonomous passenger vehicle system 200 utilizes the control network 300 configured to implement autonomous driving 306 indicative of a passenger's plan 207 or indicative of a control network plan 208 executed by a virtual operator in real-time, wherein the control network 300 is in contact with the autonomous passenger vehicle 100 when passengers are presently onboard or when passengers are not presently onboard. The control network 300 generates a control network plan 208 with respect to feedback of external sensors including LIIDAR 201a and/or radar 201b which detect threats and obstacles in an environment of the autonomous passenger vehicle 100 during autonomous navigation, the navigation system associated with determining GPS routes based on a control network plan 208. The navigation system 205, for example, transmits the target route information of the autonomous passenger vehicle 100.

The control unit 209 outputs a control signal corresponding to the control network plan 208 to the control unit 209, in this way, the control unit 209 controls the travelling of the autonomous passenger vehicle 100 such that the autonomous driving 306 can be executed according to the control network plan 208 operation acquired by the operation amount acquisition unit which is calculated by the calculation unit step exampled herein.

For example, the communication path of autonomous passenger vehicle 100 can include wireless interface within, optical communication, ultrasonic communication, or the combination thereof. For example, satellite communication 605, cellular communication, Bluetooth connecting with the user terminal via Wi-Fi or Bluetooth®, Infrared Data Association standard (IrDA), wireless fidelity (Wi-Fi), and worldwide interoperability for microwave access (WiMAX) are examples of wireless communication that can be included in the communication path. Cable, Ethernet, digital subscriber line (DSL), fiber optic lines, fiber to the home (FTTH), and plain old telephone service (POTS) are examples of wired communication that can be included in the communication path. Further, the communication path can traverse a number of control network 300 topologies and distances. For example, a communication path can include direct connection, personal area network (PAN), local area network (LAN), metropolitan area network (MAN), wide area network (WAN), or a combination thereof. The control system 101 can further execute software programming to include interaction with the communication path the connect passenger's interface 101(I) with a virtual operator 301 at the control network 300.

For example, the navigation system 205 utilizes detection devices configured to detect an external situation which is peripheral information of the autonomous passenger vehicle 100 in which LIDAR 201a detects the obstacle outside the autonomous passenger vehicle 100 using light. The LIDAR 201a transmits the light to the surroundings of the autonomous passenger vehicle 100, measures the distance to the reflection point by receiving the light reflected from the obstacle, and then, detects the obstacle. The LIDAR 201a can output, for example, the distance or direction to the obstacle as the obstacle information of the obstacle. The LIDAR 201a outputs the detected obstacle information to the autonomous passenger vehicle 100.

For example, the navigation system 205 utilizes detection devices configured to detect an external situation which is peripheral information of the autonomous passenger vehicle 100, and radar 201b detects an obstacle outside of the autonomous passenger vehicle 100 using a radio wave. The radio wave is, for example, a millimeter wave. The radar 201b detects the obstacle by transmitting the radio wave to the surroundings of the autonomous passenger vehicle 100 and receiving the wave reflected from the obstacle. The radar outputs, for example, the distance or direction to the obstacle as obstacle information of the obstacle. The radar outputs detected obstacle information to the autonomous passenger vehicle 100. In a case of performing sensor fusion, the received information on the reflected radio wave may be output to the autonomous passenger vehicle 100.

In a case of performing sensor fusion, the received information on the reflected light may be output to the autonomous passenger vehicle 100. The LIDAR 201a, and the radar 201b are not necessarily provided in an overlapping manner.

For example, external cameras 202 providing imaging of an external situation of the autonomous passenger vehicle 100. The camera 202 is, for example, provided on the frame sections of the autonomous passenger vehicle 100. The camera 202c may be a monocular camera 202a or may be a stereo camera 202b. The stereo camera 202c has, for example, two imaging units that are arranged so as to reproduce a binocular parallax. The image information of the stereo camera 202c also includes information on the depth direction. The camera 202 outputs the image information relating to the external situation to the of the autonomous passenger vehicle 100. In addition, the camera 202 may be an infrared camera 202d or a visible light camera 202e.

For example, GPS 203 receives signals from three or more GPS satellites and acquires position information indicating the position of the autonomous passenger vehicle 100. The latitude and the longitude of the autonomous passenger vehicle 100 may be included in the position information. The GPS 203 receiver 203a outputs the measured position information of the autonomous passenger vehicle 100. Instead of the GPS 203 another means for specifying the latitude and the longitude at which the autonomous passenger vehicle 100 is present may be used.

The map database 203a is a database in which map information is included. The map database 203a is formed, for example, in a hard disk drive (HDD) mounted on the autonomous passenger vehicle 100. In the map information, for example, position information of roads, information on road types, and position information of intersections, and branch points are included. For example, type of a curve or a straight portion and a curvature of the curve are included in the information on the road type.

Furthermore when engaged by the navigation system 205, the autonomous driving 306 adjust position information for simultaneous localization and mapping technology (SLAM), the map information may include an output signal of the external sensors 201, cameras 202 and the GPS map database 203a may be stored in a computer in a facility such as an information processing center which is capable of communicating with autonomous passenger vehicle 100.

For example, the navigation system 205 is a device configured to perform guidance to a destination set on the map by a passenger's 101 and calculates a travelling route of the autonomous passenger vehicle 100 based on the position information of the autonomous passenger vehicle 100 measured by the GPS 203 uses a receiver and the map information in the map database 203a. The route may be a route on which a travelling lane is specified, in which the autonomous passenger vehicle 100 travels in a multi-lane section.

The navigation system 205 calculates, for example, a target route from the position of the autonomous passenger vehicle 100 to the destination and performs notification to the passenger's 101 by auxiliary devices 204 like lights 204a, speakers 204b.

For example, the communication path of autonomous passenger vehicle 100 can include wireless passenger's interface method of controlling an autonomous passenger vehicle 100, comprising the steps of: storing a software application for remotely controlling an autonomous passenger vehicle 100 with a smartphone 602; establishing a short-range wireless communication link between the smartphone 602 and the autonomous passenger vehicle 100 when the smartphone 602 is at the autonomous passenger vehicle 100; receiving data via the short-range wireless communication link from the autonomous passenger vehicle 100 that is used by the software application to display a menu of telematics service selections at the smartphone 602; receiving a telematics service selection from an autonomous passenger vehicle 100 occupant using the smartphone 602 that is chosen from one of the displayed telematics service selections; and transmitting a command that controls at least one function of the autonomous passenger vehicle 100 based on the received telematics service selection from the smartphone 602 to the autonomous passenger vehicle 100 over the short-range wireless communication link.

The auxiliary components or (A-components 204) are subsystem devices may include a telematics Control Unit (TCU) or (acquisition network 600) may involve: receiving data via the short-range wireless communication link from the acquisition network that is used by the software application to display a menu of telematics service selections on a smartphone having a mobile APP; transmitting a command that controls at least one function of the autonomous passenger vehicle based on the received telematics service selection from the smartphone or provide other indicative instruction.

The autonomous passenger vehicle system 200 may involve an operation amount acquisition unit providing; an environment recognition unit, a control network plan 208 generation unit, thusly as the above-described operation amount acquisition unit is performed by loading the program stored in the ROM into the RAM and executing the control unit programming, a central processing unit (CPU), read only memory (ROM), random access memory (RAM), and various processes and steps exampled herein.

The operation amount acquisition unit acquires the amount of the steering operation, the acceleration operation and the braking operation by the passenger's 101 of the autonomous passenger vehicle 100 during the autonomous driving 306 based on the information acquired by the internal sensor 203. The amount of operation is, for example, the steering angle of the steering column 105, the steering torque with respect to the steering column 105, the amount of depression on the throttle controller 7, the amount of depression on the brake controller 8, or the operation force on the brake controller. Alternatively, the amount of operation may be a duration of a state in which the steering angle of the steering column 105, the steering torque with respect to the steering column 105, the amount of depression on the throttle controller, the amount of depression on the brake controller, or the operation force on the brake controller is equal to or greater than a threshold value set in advance. The operation amount acquisition unit may also be configured as an operation amount acquirer.

The environment recognition unit step recognizes the surrounding environment of the autonomous passenger vehicle 100 based on the information acquired by one or more of the external sensor 201-202, the GPS 202, receiver 202a, and the map database 202b. The environment recognition unit step includes an obstacle recognition unit step, a road width recognition unit step 14, and a facility recognition unit step. The obstacle recognition unit step recognizes the obstacle around the autonomous passenger vehicle 100 as a status of the surrounding environment of the autonomous passenger vehicle 100 based on the information acquired by the external sensors 201. For example, a pedestrian, another vehicle, a moving object such as a common motorcycle or a common bicycle, a lane boundary line (lane line, yellow line), a stationary object such as a curb, a guardrail, a pole, a median strip, a building, or a tree may be included in obstacles recognized by the obstacle recognition unit step. The obstacle recognition unit step acquires information on one or more of a distance between the obstacle and the autonomous passenger vehicle 100, a position of the obstacle, a relative speed of the obstacle with respect to the autonomous passenger vehicle 100, and a type of obstacle. The type of obstacle may be identified as a pedestrian, another vehicle, a moving object or a stationary object. The environment recognition unit step may be configured as an environment recognizer. Furthermore, the obstacle recognition unit step may be configured as an obstacle recognizer.

The road width recognition unit step recognizes a road width of the road on which the autonomous passenger vehicle 100 travels as the surrounding environment of the autonomous passenger vehicle 100 based on the information acquired by one or more of the external sensors.

The control network 300 recognizes whether or not the autonomous passenger vehicle 100 control network plan 208 is a route for traveling on a bicycle lane, on a street, or driving through an intersection or a parking lot as the surrounding environment in which the autonomous passenger vehicle 100 control network plan 208 based on one or more of the map information acquired by the map database and the position information of the autonomous passenger vehicle 100 acquired by the GPS 203. For example, as the surrounding environment of the autonomous passenger vehicle 100 based on the map information and position information of the autonomous passenger vehicle 100, in which the road has potential threats or obstacles.

The generation unit generates a control network plan 208 for the autonomous passenger vehicle 100 based on the information on the target route calculated by the navigation system 205, the information of the obstacle around the autonomous passenger vehicle 100 recognized by the environment recognition unit step, and the map information acquired by the map database. The control network plan 208 is a trajectory of the autonomous passenger vehicle 100 on the target route. For example, a speed, an acceleration, a deceleration, a direction, and a steering angle of the autonomous passenger vehicle 100 may be included in the control network plan 208. The control network plan 208 may involve a generation unit which generates a control network plan 208 such that the autonomous passenger vehicle 100 can travel while satisfying standards such as a safety, regulatory compliance, and driving efficiency on the target route. Furthermore, the control network plan generation unit generates a control network plan 208 for the autonomous passenger vehicle 100 so as to avoid contact with an obstacle based on the situation of the obstacle around the autonomous passenger vehicle 100.

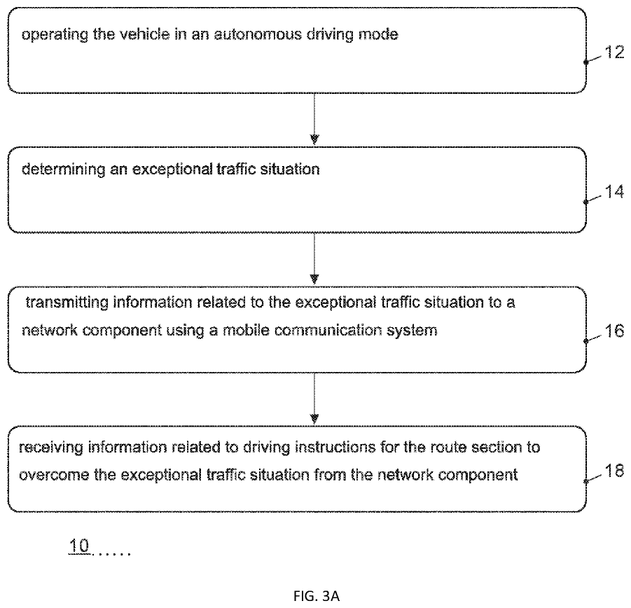

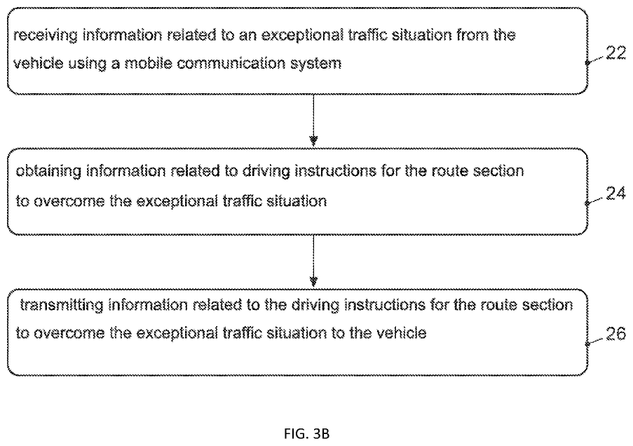

In greater detail FIG. 3A illustrates a block diagram of a disclosed embodiment of a method 10 an autonomous passenger vehicle 100 to determine a route section. The method 10 comprises operating 12 the autonomous passenger vehicle 100 in an autonomous/automated driving mode and determining 14 an exceptional traffic situation. The method 10 further comprises transmitting 16 information related to the exceptional traffic situation to a network component using a mobile communication system. The method further comprises receiving 18 information related to driving instructions for the route section to overcome the exceptional traffic situation from the network component.

In greater detail FIG. 3B illustrates a block diagram of a disclosed embodiment of a method 20 for a network component to determine a route section for an autonomous passenger vehicle 100. The method 20 comprises receiving 22 information related to an exceptional traffic situation from the autonomous passenger vehicle 100 using a mobile communication system. The method 20 further comprises obtaining 24 information related to driving instructions for the route section to overcome the exceptional traffic situation. The method 20 further comprises transmitting 26 information related to the driving instructions for the route section to overcome the exceptional traffic situation to the autonomous passenger vehicle 100. As will be explained in more detail subsequently, examples for the information related to the driving instructions are control information from a remote-control center (tele-operated driving), information related to a stored path (determined before), which is known to overcome the unexpected traffic situation, or instructions to manually operate the autonomous passenger vehicle 100.

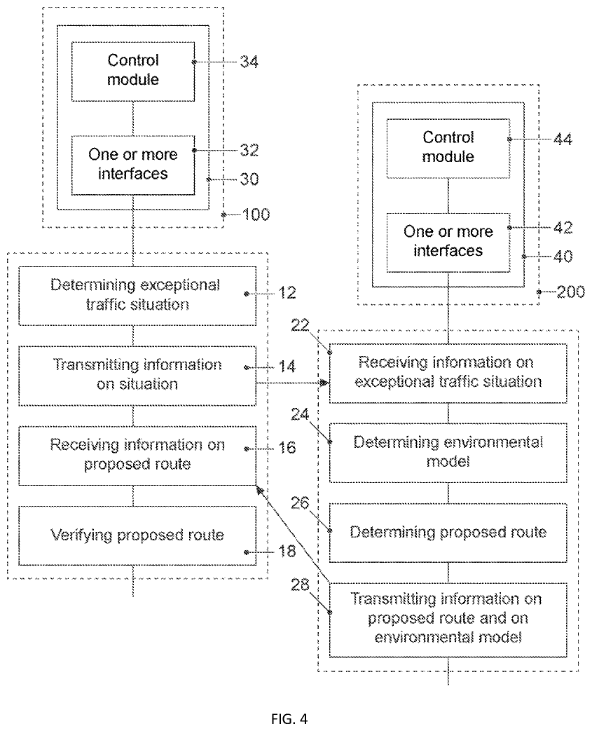

In greater detail FIG. 4 is a chart of the control network 300, the control network is wirelessly in communication with the autonomous passenger vehicle system 200 and the control unit 209. The control network 300 is configured to control the travelling of the autonomous passenger vehicle 100 based on the control network plan 208 generated by the control network plan generation unit and executed by the navigation system 205 when the passenger's 101 is not engaged (paying attention) or distracted, or when the autonomous passenger vehicle is unmanned.

The control network 300 receives outputs a control signal corresponding to the control unit 209. In this way, the control network 300 controls the travelling of the autonomous passenger vehicle 100 such that the autonomous driving 306 of the autonomous passenger vehicle 100 receives outputs a control signal corresponding to driving to a destination 209/210 indicative of the passenger's plan 101(P).

The control network 300 is systematically connected to the autonomous passenger vehicle's electronic components (E-Components) sensors 21-210, the external sensors 201-202, GPS 203, providing data of manual driving 304 and providing data from autonomous driving 306 to the remote operation 301. Systematically via programming a computer of the control network 300 provides a calculation unit processors for calculating the threshold value for switching to manual driving 304 according to the surrounding environment of the autonomous passenger vehicle 100 recognized by the environment recognition unit step. As described below, when the obstacle is recognized by the obstacle recognition unit step of the environment recognition unit step, the calculation unit step may calculate the threshold value for switching to manual driving 304 according to the distance between the obstacle and the autonomous passenger vehicle 100 and the type of obstacle. In addition, when the obstacle is not recognized by the obstacle recognition unit step of the environment recognition unit step, the calculation unit step may calculate the threshold value for switching to manual driving 304 according to one or more of the road width of the road on which the autonomous passenger vehicle 100 travels and a type of facilities such as a parking lot on which the autonomous passenger vehicle 100 travels. As described below, a function describing the threshold value for switching to manual driving 304 corresponding to the surrounding environment of the autonomous passenger vehicle 100 is stored in the autonomous passenger vehicle 100.

FIG. 4 shows a disclosed embodiment of an apparatus 30 for a UE or autonomous passenger vehicle 100, a disclosed embodiment of an apparatus 40 for a network component, and a disclosed embodiment of a system 400. The apparatus 30 for the UE/autonomous passenger vehicle 100 comprises one or more interfaces 32 configured to communicate in the control network 300. The apparatus 30 further comprises a control module 34, which is coupled to the one or more interfaces 32 and which is configured to control the one or more interfaces 32. The control module 34 is further configured to perform one of the methods 10 as described herein.

The apparatus 40 for the network component 200 comprises one or more interfaces 42, which are configured to communicate in the control network 300. The apparatus 40 further comprises a control module 44, which is coupled to the one or more interfaces 42 and which is configured to control the one or more interfaces 42. The control module 44 is further configured to perform one of the methods 20 as described herein. The apparatus 40 may be comprised in a CC 200, a base station, a NodeB, a UE, a relay station, or any service coordinating network entity in disclosed embodiments. It is to be noted that the term network component may comprise multiple sub-components, such as a base station, a server, a CC 200, etc. A further disclosed embodiment is an autonomous passenger vehicle 100 comprising the apparatus 30 and/or a network component 200 comprising the apparatus 40.

In disclosed embodiments the one or more interfaces 32, 42 may correspond to any method or mechanism for obtaining, receiving, transmitting or providing analog or digital signals or information, e.g., any connector, contact, pin, register, input port, output port, conductor, lane, etc. which allows providing or obtaining a signal or information. An interface may be configured to communicate, i.e., transmit or receive signals, information with further internal or external components. The one or more interfaces 32, 42 may comprise further components to enable communication in the control network 300, such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers are adapted via radio frequency components, etc. The one or more interfaces 32, 42 may be coupled to one or more antennas, which may correspond to any transmit and/or receive antennas, such as horn antennas, dipole antennas, patch antennas, sector antennas etc. The antennas may be arranged in a defined geometrical setting, such as a uniform array, a linear array, a circular array, a triangular array, a uniform field antenna, a field array, combinations thereof, etc. In some examples the one or more interfaces 32, 42 may serve the purpose of transmitting or receiving or both, transmitting and receiving, information, such as information related to capabilities, application requirements, trigger indications, requests, message interface configurations, feedback, information related to control commands, QoS requirements, QoS time courses, QoS maps, etc.

As shown in FIG. 4 the respective one or more interfaces 32, 42 are coupled to the respective control modules 34, 44 at the apparatuses 30, 40. In disclosed embodiments the control modules 34, 44 may be implemented using one or more processing units, one or more processing devices, any method or mechanism for processing, such as a processor, a computer or a programmable hardware component being operable with CC adapted software. In other words, the described functions of the control modules 34, 44 may as well be implemented in software, which is then executed on one or more programmable hardware components. Such hardware components may comprise a general purpose processor, a Digital Signal Processor (DSP), a micro-controller, etc.

FIG. 4 also shows a disclosed embodiment of a system 400 comprising disclosed embodiments of UE/autonomous passenger vehicle 100, and a network component/base station 200 comprising the apparatus 40. In disclosed embodiments, communication, i.e., transmission, reception or both, may take place among mobile transceivers/autonomous passenger vehicles 100 directly and/or between mobile transceivers/autonomous passenger vehicles 100 and a network component 200 (infrastructure or mobile transceiver, e.g., a base station, a network server, a backend server, etc.). Such communication may make use of a control network 300. Such communication may be carried out directly, e.g., by Device-to-Device (D2D) communication, which may also comprise Vehicle-to-Vehicle (V2V) or car-to-car communication in case of autonomous passenger vehicles 100. Such communication may be carried out using the specifications of a control network 300.

In disclosed embodiments the one or more interfaces 32, 42 can be configured to wirelessly communicate in the control network 300. To do so, radio resources are used, e.g., frequency, time, code, and/or spatial resources, which may be used for wireless communication with a base station transceiver as well as for direct communication. The assignment of the radio resources may be controlled by a base station transceiver, i.e., the determination which resources are used for D2D and which are not. Here and in the following radio resources of the respective components may correspond to any radio resources conceivable on radio carriers and they may use the same or different granularities on the respective carriers. The radio resources may correspond to a Resource Block (RB as in LTE/LTE-A/LTE-unlicensed (LTE-U)), one or more carriers, sub-carriers, one or more radio frames, radio sub-frames, radio slots, one or more code sequences potentially with a respective spreading factor, one or more spatial resources, such as spatial sub-channels, spatial precoding vectors, any combination thereof, etc.

For example, in direct Cellular Vehicle-to-Anything (C-V2X), where V2X includes at least V2V, V2-Infrastructure (V21), etc., transmission according to 3GPP Release 14 onward can be managed by infrastructure (so-called mode 3) or run in a UE.

FIG. 4 also illustrates the methods 10 and 20 as described above. The apparatus 30 of the autonomous passenger vehicle 100 operated the autonomous passenger vehicle 100 in automated mode 12 if an exceptional traffic situation is determined 14. Such an exceptional situation may be any traffic situation that is unexpected or differs from an expectation according to routing information or map information available in the autonomous passenger vehicle 100. For example, the road may be blocked by another autonomous passenger vehicle, a construction side, an accident, flooding etc. Other exceptions may be a closed road, a closed tunnel, unexpected road conditions etc. The autonomous passenger vehicle itself may operate multiple sensor systems capturing data of the autonomous passenger vehicle's environment. Such data may comprise video data, imaging data, radar data, lidar data (light detection and ranging), temperature data, air pressure data, radio environment data, information received from other autonomous passenger vehicles, etc. Based on this data a matching can be carried out between the assigned route for automated driving and the sensor data. In some disclosed embodiments, as will be detailed in the sequel, the captured data is used to generate an environmental model of the autonomous passenger vehicle. This model may be a digital representation of the environment of the autonomous passenger vehicle possibly including other autonomous passenger vehicles, objects, roadside infrastructure, traffic signs, pedestrians, etc. Based on this model an unexpected situation can be detected, e.g., an obstacle is detected in the way and passing the obstacle would require passing through a forbidden area, e.g., sidewalk, opposite lane, etc. In some disclosed embodiments the exceptional situation may as well be determined by receiving a traffic message, e.g., a broadcast message from another autonomous passenger vehicle 100 or common vehicle.

As further shown in FIG. 4 the autonomous passenger vehicle 100 then transmits information related to the exceptional traffic situation to the network component 200 using a control network 300. From the perspective of the network component 200 the information related to the exceptional traffic situation is received 22 from the autonomous passenger vehicle 100. At the network component 200 information related to driving instructions for the route section to overcome the exceptional traffic situation can be obtained 24. Finally, information related to the instructions can be transmitted 26 back to the autonomous passenger vehicle 100, received 18 at the autonomous passenger vehicle 100, respectively.

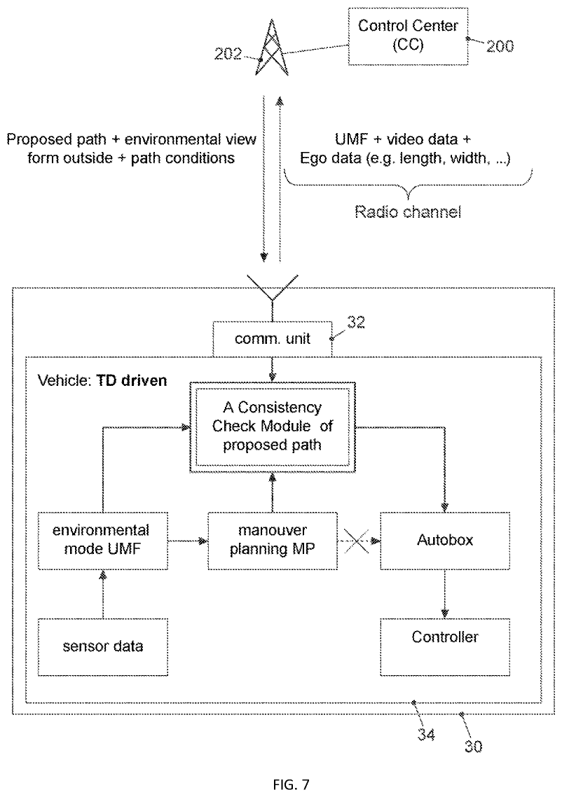

Disclosed embodiments may provide a concept for tele-operated driving based on a slim uplink and a locally proposed path. Tele-operated Driving (TD) is getting more and more interest. The main concept of TD is an autonomous passenger vehicle remotely driven by a control center (CC 200). Between CC 200 and autonomous passenger vehicle may be a large distance. They are connected via a radio communication system (e.g., 5G, 4G) and their backhaul. In a disclosed embodiment a fully automatically driving autonomous passenger vehicle gets stopped (also referred to as SAE (Society of Automotive Engineers) level 5 (L5) autonomous passenger vehicle). For example, the automated autonomous passenger vehicle is not able to continue its planed route because it is not able to interpret the situation. FIG. 7 illustrates an exceptional traffic scenario in a disclosed embodiment, where a common vehicle is blocking a one-way road.

It is assumed that other vehicles are autonomous vehicles (L5). They would need to drive on the sidewalk to continue their planed route. In some disclosed embodiments TD provides a solution for this scenario.

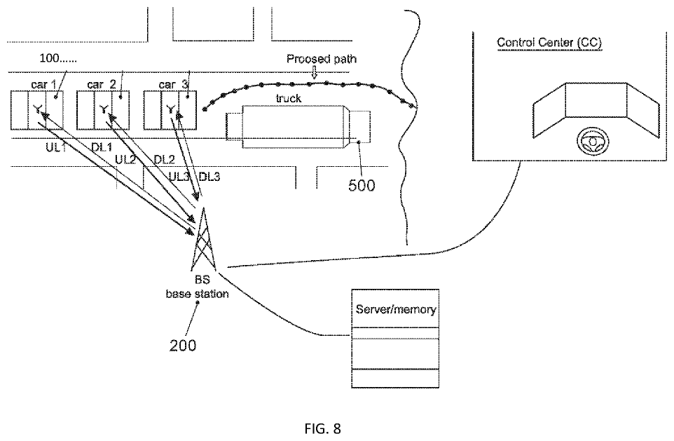

Autonomous passenger vehicles controlled via remote control are uploading high data streams in the uplink (UL) to the CC 200. In FIG. 8 it is assumed that the network component 200 comprises a base station (BS), the CC 200 and some server/memory. As has been outlined above, in other disclosed embodiments these components might not be collocated but located at different locations. In this description the term network component 200 shall summarize these components as one functional entity although they may be implemented as multiple physical entities. The distance between CC 200 and the autonomous passenger vehicle 100 may contribute to the latency of any driving instructions before reaching the autonomous passenger vehicle and any data (video, sensor, etc.) being transmitted from the autonomous passenger vehicle to the CC 200.

The data steams provided by a remotely or tele-operated autonomous passenger vehicle may comprise radar images, LIDAR and camera data. Close by driving cars are “seeing” the same environment around them. This redundant data is considerable amount of bandwidth in the UL. For current technologies such as 4G, the UL is expected to be a bottleneck as the network was designed to support high downlink (DL) and low UL data rates. For TD it is vice versa: high UL (sensor data) and low DL (control data). Latency is also an issue here. Furthermore, each car needs to be driven manually via remote control. This implies that many drivers are needed. In such a disclosed embodiment the receiving 18 of the driving instructions comprises tele-operating the autonomous passenger vehicle along the route section to overcome the exceptional traffic situation. Moreover, information related to an environmental model of the autonomous passenger vehicle may be provided to the network component in addition to the information related to the exceptional traffic situation. The information on the environmental model may allow decreasing a subsequent video data rate on the uplink High data rates usually needed in the UL for teleoperated driving may be decreased in disclosed embodiments. In disclosed embodiments information related to autonomous passenger vehicle data and video data (e.g., with reduced data rate) may be provided to the network component in addition to the information related to the exceptional traffic situation.

Each autonomous passenger vehicle 100 may be controlled by one driver in the CC 200. Disclosed embodiments are further based on the finding that a path driven remotely by the CC 200 might be highly redundant with the path from a car remotely driven before. At least some disclosed embodiments therefore store information related to a route information or information related to driving instructions solving an unexpected traffic situation, such that the information can be re-used later on to solve the situation for other autonomous passenger vehicles as well. In disclosed embodiments the storage or memory for storing information related to a path or a route may be any device capable of storing such information, examples are a hard drive, a flash drive, an optical storage medium, a magnetic storage medium, a solid state memory, any mass storage device, etc.

As has been described above, different options are conceivable in disclosed embodiments to determine the route section leading out of the exceptional traffic situation. For example, the CC 200 proposes a path (route section) based on the received environmental model, autonomous passenger vehicle data and video data. The proposed path is stored on a server close to the geographical location of the path and might be used by other autonomous passenger vehicles 101, 102 after internal verification (plausibility check).

Instead of transmitting all sensor data to the CC 200, the autonomous passenger vehicle may upload its environmental model plus some video data in some disclosed embodiments. The proposed path may be drawn (maybe just a few points) at the CC 200 or slowly driven by CC driver.

The procedure/method may be implemented as following in a further disclosed embodiment:

1. First an autonomous passenger vehicle 100 stops and it calls the CC 200;

2. If there is not a proposed path at local server, it gets connected with the CC 200;

3. Autonomous passenger vehicle 100 transmits the environmental model and video data to the CC 200;

4. There are multiple options for determining the proposed path or route section.

a) The CC 200 drives autonomous passenger vehicle 100 remotely and creates the proposed path (for next autonomous passenger vehicle 100, and so on). The obtaining 24 of the information related to the driving instructions comprises tele-operating the autonomous passenger vehicle out of the exceptional traffic situation. This can be also based on transmitted environmental model data.

b) autonomous passenger vehicle 100 is driving by itself based on the proposed path (drawn with UMF+video by the CC 200). In this case the receiving 18 of the driving instructions comprises receiving information on the route section from the network component 200 and the method 10 comprises automatically operating the autonomous passenger vehicle along the route section. The method 20 further comprises receiving information related to an environmental model of the autonomous passenger vehicle from the autonomous passenger vehicle 100. The obtaining 24 of the information related to the driving instructions comprises determining information related to the route section based on the information related to the environmental model of the autonomous passenger vehicle.

c) the receiving 18 of the driving instructions comprises an instruction to manually operate the autonomous passenger vehicle out of the exceptional traffic situation. The route section is determined by manually operating the autonomous passenger vehicle out of the exceptional traffic situation. The method 10 further comprises transmitting information related to the route section to the network component. From the perspective of the network component 200 the obtaining 24 of the information related to the driving instructions comprises instructing a user of the autonomous passenger vehicle to manually operate the autonomous passenger vehicle 100 out of the exceptional traffic situation.

5. In all cases the proposed/determined path is stored or updated at a server close to the location of the path/route section. Hence, the method 20 at the network component 200 further comprises storing information related to the route section in a storage/memory. The obtaining 24 of method 20 of the information related to the driving instructions may comprise retrieving previously stored information related to the route section from the storage/memory. The method 200 further comprises storing information related to the route section in a storage/memory.

6. The first autonomous passenger vehicle 100 is located at the old position of the autonomous passenger vehicle 100.

7. The second autonomous passenger vehicle 100 is also calling the CC 200 but is connected with the server as there is a proposed path. Car 101 gets the proposed path from the server. Then 8. Begins.

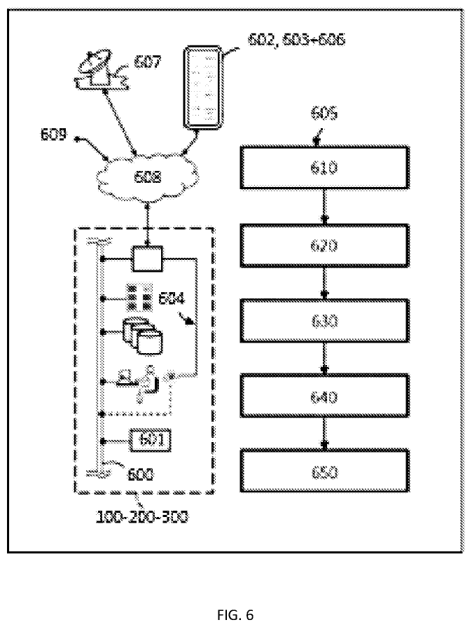

In greater detail FIG. 6 there is shown a telematic unit 600 operating environment of an autonomous passenger vehicle 100, the acquisition network works as communications system linking the passenger's to the autonomous passenger vehicle system 200 with her or his smartphone 602 or (smartphone interface) the passenger's uses a visual display 603 to CC 200 features provided by one or more wireless carrier systems 604 associated with any number of different systems that can link to the autonomous passenger vehicle system 200 and to the control network 300 by an onboard control panel 21 linked with external and auxiliary smart devices 211 or to a handheld wireless device such as the passenger's smartphone 602 or wearable smart devices like a smart helmet having a virtual display to communicate with the systems 200-300 through the acquisition network 600 via a wireless communication link 605.

It should be understood that the disclosed acquisition network 600 method is not specifically limited to the operating environment shown here. Also, the architecture, construction, setup, and operation of individual components are generally known in the art. Thus, the following paragraphs simply provide a brief overview of one such exemplary system however, other systems not shown here could employ the disclosed method as well.

The smart devices 211 connect to the control panel 21 and the smartphone 602 can carry out communication and control features of the acquisition network 600 when using a software application stored at the control panel 21. While some autonomous passenger vehicles 100 carry acquisition networks that can monitor autonomous passenger vehicle 100 functions and wirelessly communicate data over a wireless communication link 605 of a passenger's smartphone 602 can communicate using short-range wireless communication by Bluetooth 606 protocols, cellular communications over a wireless carrier system 603. Sensor data can be received by the smart devices 211 data, or by a smartphone 602 data from the acquisition network 600 is stored in Cloud 607 associated with the control network 300.

One of the networked devices that can communicate with the acquisition network 600 is a smart device 211, 602. The smart device 211, 602 can include computer processing capability, a transceiver capable of communicating using a short-range wireless protocol, and a visual smart device display. In some implementations, the control panel 21 also includes a touch-screen graphical user interface and/or a GPS capable of receiving GPS satellite signals 608 and generating GPS coordinates based on those signals. Examples of the smart devices may include the iPhone™ manufactured by Apple, Inc. and the Android™ manufactured by Motorola, Inc. While the smart devices may also include the ability to communicate via cellular communications using the wireless carrier system, this is not always the case. For instance, Apple manufactures devices such as the iPad™, iPad, and the iPod Touch™ that include the processing capability, the display 603, and the ability to communicate over a wireless communication link 605. However, the iPod Touch and some iPads do not have cellular communication capabilities. Even so, these and other similar devices may be used or considered a type of smart device 211, 602 for the purposes of the method described herein.

When a passenger's 101 carries a control panel 21 or passenger's smartphone 602, the acquisition network 600 can then use the display 603 of that smart devices to show the passenger's 101 more detailed information, such as a menu containing a plurality of geographical maps used to provide turn-by-turn directions displayed on the smartphone 602 or on the smart device 211, 602 in which the passenger 101 and transmit the more detailed information to the acquisition network

In another example, the acquisition network 600 can also determine that the smart device 211, 602 is capable of greater wireless data communication speeds than can be achieved by the acquisition network. As a result, the acquisition network 600 can leverage the wireless communication capability of the smart device 211, 602 to transmit and receive data via the smart device 211, 602 over a cellular wireless communication system by transferring data between the acquisition network and the smart device 211, 602 over the wireless communication link 605. In short, the combination of the display and control features of the smart device 211, 602 can be integrated with the communication, autonomous passenger vehicle 100 monitoring, and information generated control networking between the autonomous passenger vehicle 100 and other networked devices can also be carried out using acquisition network 600. For this purpose, acquisition network 600 can be configured to communicate wirelessly CC 200 according to one or more wireless protocols, such as any of the IEEE 602.11 protocols, WiMAX, or Bluetooth 606. When used for packet-switched data communication such as TCP/IP, the acquisition network can be configured with a static IP address or can set up to automatically receive an assigned IP address from another device on the network such as a router or from a network address server.

ACC 200ording to one embodiment, the processors of the smartphone 602 can be any type of device capable of processing electronic instructions including microprocessors, microcontrollers, host processors, controllers, autonomous passenger vehicle 100 communication processors, and application specific integrated circuits (ASICs). It can be a dedicated processor used only for acquisition network 600 or can be shared with other autonomous passenger vehicle 100 systems. The one or processors executes various types of digitally-stored instructions, such as software or firmware programs stored in memory or Cloud 607, which enable the acquisition network to provide a wide variety of services. For instance, a number of processors can execute programs or process data to carry out at least a part of the method discussed herein.

ACC 200ording to one embodiment, the acquisition network 600 can be used to provide a diverse range of autonomous passenger vehicle 100 services that involve rental acquisition of the autonomous passenger vehicle 100.

For instance the control network 300 receives radio signals from GPS satellites. From these signals, the GPS 203 can determine autonomous passenger vehicle 100 position that is used for providing navigation and other position-related services to the autonomous passenger vehicle 100. The navigation services can be provided using a dedicated acquisition network 600, wherein the position information with navigation maps, map annotations (points of interest, restaurants, etc.), route calculations, and the like. The position information can be supplied to call center or other remote computer system, such as the control network 300, for other purposes, such as fleet management 610. Also, new or updated map data can be downloaded to the GPS 203 from the call center via the acquisition network 600.

ACC 200ording to one embodiment, the electrical system elements 200-300 also include a number of autonomous passenger vehicle 100 user interfaces that provide the passenger 101 with a means of providing and/or receiving information, including microphone, audio system connected to the control panel's virtual display for passenger's plan 101(P). Various operator interfaces can also be utilized, as the passenger's 101 interface detailed of FIG. 2-FIG. 4 which are only an example of one particular implementation related to the control network 300.

As used herein, the term ‘autonomous passenger vehicle 100 user interface’ broadly includes any suitable form of electronic device, including both hardware and software components, which is located on the autonomous passenger vehicle 100 and enables an autonomous passenger vehicle 100 user to communicate with or through a component of the autonomous passenger vehicle 100. Microphone provides audio input to the acquisition network to enable the driver or other passenger's 101 to provide voice commands and carry out hands-free calling via the wireless carrier system 606.

ACC 200ording to one embodiment, the wireless carrier system 606 is preferably a cellular telephone system that includes networking components required to connect wireless carrier system with land network. Each cell tower includes sending and receiving antennas and a base station, with the base stations from different cell towers being connected to the MSC either directly or via intermediary equipment such as a base station operator. Cellular system can implement any suitable communications technology, including for example, analog technologies such as AMPS, or the newer digital technologies such as CDMA (e.g., CDMA8000) or GSM/GPRS. As will be appreciated by those skilled in the art, various cell tower/base station/MSC arrangements are possible and could be used with wireless system. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system, a different wireless carrier system in the form of satellite communication can be used to provide uni-directional or bi-directional communication with the autonomous passenger vehicle 100. This can be done using one or more communication satellites and an uplink transmitting station. Uni-directional communication can be, for example, satellite radio services, wherein programming content (news, music, etc.) is received by transmitting station, packaged for upload, and then sent to the satellite, which broadcasts the programming to subscribers. Bi-directional communication can be, for example, satellite telephony services using satellite 605 to relay telephone communications between the autonomous passenger vehicle 100 and the control network 300. If used, this satellite telephony can be utilized either in addition to or in lieu of wireless carrier system.

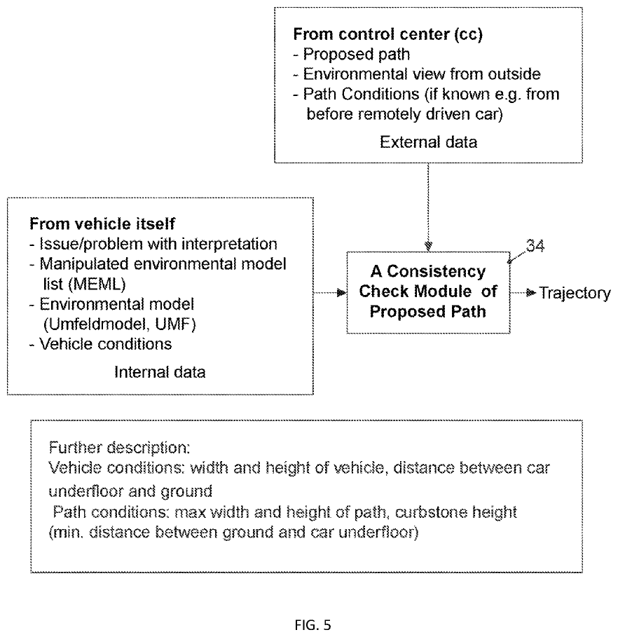

In greater detail FIG. 5 illustrates a generic overview of logical modules in a disclosed embodiment. FIG. 7 shows an implementation of a control module 34 in a disclosed embodiment of an apparatus 30 in a transportation vehicle 100. In this disclosed embodiment the control module 34 comprises multiple further modules, such as a sensor data processing module, an environmental model generation module, a maneuver planning module (MP), a consistency check module for the proposed path, an auto-box, which is in charge for automated driving and which controls a steering controller of the transportation vehicle. The different modules shown in FIG. 4 may be different software modules running on the same processor or hardware. In other disclosed embodiments they may be fully or partly implemented on different processors/controllers or on multiple processors/controllers, which are coupled to each other via respective interfaces.

As shown in FIG. 5 the control module 34 is coupled to a communication unit 32, which is an interface to communicate with a CC 200 via mobile communications, e.g., a 4G/5G base station 202. The control module 34 uses the consistency check module to verify whether the received proposed path is consistent. A consistency check may increase the trust level in the proposed path as the transportation vehicle 100 performs additional internal tests. FIG. 7 is a generic overview of the logical modules at the remotely driven transportation vehicle 100 (left), the radio interference (middle), and the control center 200 (CC 200) located somewhere else (right). The crossed arrow from the MP module to auto-box indicates that for the exceptional traffic situation the MP cannot provide a resolving route. Therefore, the CC 200 is contacted, and the received proposed route is verified/consistency checked.

As shown in FIG. 5 the transportation vehicle apparatus 30 communicates information related to the environmental model, video data, and ego data (e.g., geometrics of the transportation vehicle, length, width, etc.) to the network component 200. In return the apparatus 30 receives information related to the proposed path, the environmental view from the outside (network perspective of the environment of the transportation vehicle 100) and path conditions (for example, road condition (such road ice, aqua planning, height limitation, width limitations), traffic situation, etc.).

The control network 300, as shown in FIG. 4, may, for example, correspond to one of the Third Generation Partnership Project (3GPP)-standardized mobile communication networks, where the term mobile communication system is used synonymously to a transceiver which may involving a wireless communication system 400 may correspond to a mobile communication system of the 5th Generation (5G, or New Radio) and may use mm-Wave technology. The mobile communication system may correspond to or comprise, for example, a Long-Term Evolution (LTE), an LTE-Advanced (LTE-A), High Speed Packet ACC 200ess (HSPA), a Universal Mobile Telecommunication System (UMTS) or a UMTS Terrestrial Radio ACC 200ess Network (UTRAN), an evolved-UTRAN (e-UTRAN), a Global System for Mobile communication (GSM) or Enhanced Data rates for GSM Evolution (EDGE) network, a GSM/EDGE Radio ACC 200ess Network (GERAN), or mobile communication networks with different standards, for example, a Worldwide Inter-operability for Microwave ACC 200ess (WIMAX) network IEEE 802.16 or Wireless Local Area Network (WLAN) IEEE 802.11, generally an Orthogonal Frequency Division Multiple ACC 200ess (OFDMA) network, a Time Division Multiple ACC 200ess (TDMA) network, a Code Division Multiple ACC 200ess (CDMA) network, a Wideband-CDMA (WCDMA) network, a Frequency Division Multiple ACC 200ess (FDMA) network, a Spatial Division Multiple ACC 200ess (SDMA) network, etc.

Service provision may be carried out by a control network component, such as a base station transceiver, a relay station or a UE, e.g., coordinating service provision in a cluster or group of multiple UEs. Here and in the following the network component may be a Control Center (CC 200), which controls remotely operated or tele-operated autonomous passenger vehicles such as the autonomous passenger vehicle 100. For example, it may correspond to a computer system displaying data (e.g., video streams) obtained from an autonomous passenger vehicle to an operator or remote driver of the autonomous passenger vehicle. Generally, such a CC 200 may be located as close to a controlled autonomous passenger vehicle as possible to keep a latency of the video data in an uplink and the control or steering data in the downlink as short as possible. In some disclosed embodiments communication may be carried out via a base station, which may be collocated with the CC 200 or located close to base station. Signaling may be routed directly from the CC 200 to the autonomous passenger vehicle, i.e., on the shortest path to keep the latency and delay as short as possible.

A base station transceiver can be operable or configured to communicate with one or more active mobile transceivers/autonomous passenger vehicles 100 and a base station transceiver can be located in or adjacent to a coverage area of another base station transceiver, e.g., a macro cell base station transceiver or small cell base station transceiver. Hence, disclosed embodiments may provide a control network 300 comprising two or more mobile transceivers/autonomous passenger vehicles 100 and one or more base station transceivers, wherein the base station transceivers may establish macro cells or small cells, as, e.g., pico-, metro-, or femto cells. A mobile transceiver or UE may correspond to a smartphone, a cell phone, a laptop, a notebook, a personal computer, a Personal Digital Assistant (PDA), a Universal Serial Bus (USB)— autonomous passenger vehicle etc. A mobile transceiver may also be referred to as User Equipment (UE) or mobile in line with the 3GPP terminology. An autonomous passenger vehicle may correspond to any conceivable mode of transportation, e.g., a car, a bike, a motorbike, a van, a truck, a bus, a ship, a boat, a plane, a train, a tram, etc.

A base station transceiver can be located in the fixed or stationary part of the network or system. A base station transceiver may be or correspond to a remote radio head, a transmission point, an access point, a macro cell, a small cell, a micro cell, a femto cell, a metro cell etc. A base station transceiver can be a wireless interface of a wired network, which enables transmission of radio signals to a UE or mobile transceiver. Such a radio signal may comply with radio signals as, for example, standardized by 3GPP or, generally, in line with one or more of the above listed systems. Thus, a base station transceiver may correspond to a NodeB, an eNodeB, a Base Transceiver Station (BTS), an access point, a remote radio head, a relay station, a transmission point etc., which may be further subdivided in a remote unit and a central unit.

The autonomous passenger vehicle 100 can be associated with a base station transceiver or a smartphone of the passenger.

The autonomous passenger vehicle 100 may communicate directly with each other autonomous passenger vehicle 100, i.e., without involving any base station transceiver, which is also referred to as Device-to-Device (D2D) communication. An example of D2D is direct communication between autonomous passenger vehicles, also referred to as Vehicle-to-Vehicle communication (V2V), car-to-car using 802.11p, Dedicated Short Range Communication (DSRC), respectively.

As shown in FIG. 6 is a charted method of controlling an acquisition network 600 is exampled within the lined area. The method 600 begins at step 610 by operation using the processing capabilities of the smartphone 602 of a passenger 101 or by a smart devices 211 such as PC, laptops, iPad, Tablet, and the like.

At step 620, the method detects the presence of the smart device 211, 602 that includes software capable of remotely controlling the acquisition network 600 via the wireless communication link 605 between the acquisition network 600 and the smart device 211, 602. The wireless communication link 605 can be established using any one of the short-range communication protocols discussed above. The method 800 can be described using the Bluetooth 606 protocol. The wireless communication link 605 can be established by pairing the smart device 211, 602 with the acquisition network 600. A query can be sent from the acquisition network 600 to the smart device 211, 602 that asks whether software for controlling the acquisition network 600 is installed or saved at the smart device 211, 602. If the acquisition network 600 receives a reply over the wireless communication link 605 confirming the existence of such software, the acquisition network 600 and the smart device 211, 602 can begin to communicate. The method 600 proceeds to step 630.

At step 630, the stored software communicatively connects the smart device 211, 602 with the acquisition network 600 via the wireless communication link 605. Once paired, the acquisition network 600 and/or the smart device 211, 602 can direct the software to communicate using the indicative protocol based on the Bluetooth 606 short-range wireless connections and exchange data, such as commands from the smart device 211, 602 to the acquisition network 600. The indicative protocol can wirelessly emulate serial cable line settings and the status of a serial port and can be used for the transfer of serial data. In this case, the acquisition network 600 can directly connect with the smart device 211, 602 using the indicative protocol and the pairing of the acquisition network 600 and the smart device 211, 602 can be carried out based on the indicative protocol. Over the wireless communication link—using the indicative protocol or otherwise—the acquisition network 600 can be controlled via commands that are represented by codes. In one example, these codes can be provided by a user interface table (UIT) that includes a number for each action. The UIT can be stored at the acquisition network 600 and the smart device 211, 602. That way, the UIT number can be sent over the short-range wireless communication protocol to the acquisition network 600 or the smart device 211, 602 and that number can be interpreted and translated into the appropriate command. The method 600 proceeds to step 640.

At step 640, autonomous passenger vehicle 100 data for generating a telematics service menu offering telematics service commands 606 on the smart device 211, 602 display 603 of the smart device 211, 602 is transmitted from the acquisition network 600 to the smart device 211, 602 via the wireless communication link 605 and the selection of one of the telematics service commands made by a passenger's 101 is received. Vehicle data can generally relate to the operation of the autonomous passenger vehicle 100. Examples of autonomous passenger vehicle 100 data include turn-by-turn directions, diagnostic trouble codes (DTCs), and messages received from the call center. Telematics service selections that represent commands can be chosen at the smart device 211, 602 from one of the telematics service selections displayed on the smart device 211, 602 and received in response to autonomous passenger vehicle 100 data that is displayed at the smart device 211, 602. The acquisition network 600 can provide not only autonomous passenger vehicle 100 data but also computer-readable information that the smart device 211, 602 can use to display a menu of telematics service selections. This computer-readable information can establish any one or more variables, such as the number of telematics service options presented to the passenger's 101, static data shown on the smart device 211, 602 display 603, the font of the characters displayed, the color of the smart device 211, 602 display 603, and more. In short, the computer-readable information can control the overall appearance of the information shown on the smart device 211, 602 display 603.

ACC 200ording to one embodiment, the telematics service menu used at the smart device 211, 602 can also provide master-slave status to the user of the telematics service menu via the smart device 211, 602. That is, even though the acquisition network 600 can receive selections from devices mounted on the autonomous passenger vehicle 100, such as virtual prompts, the telematics service menu use at the smart device 211, 602 may be encoded to override selections made from inputs other than those displayed on the smart device 211, 602. Thus, the smart device 211, 602 menu becomes the master control, while the other inputs are subordinate to the smart device 211, 602 menu. The method 640 proceeds to step 650.

At step 650, the selected telematics service command is transmitted to the acquisition network 600 via the wireless communication link 605 and one or more autonomous passenger vehicle 100 functions are controlled using the acquisition network 600 based on the transmitted telematics service command. This selected command can control at least one function of the autonomous passenger vehicle 100. Using the menu shown on the smart device 211, 602 display 603, the passenger 101 can select an option.

Other communications between the acquisition network 600 and the smartphone has a mobile APP 650. For instance, the mobile APP 650 provides GPS mapping where information is received through GPS satellite signals, or generate GPS coordinates, to send GPS coordinates and use those received GPS coordinates in the execution and/or presentation of the turn-by-turn directions to drive the autonomous passenger vehicle 100. In another example, the call center can send messages relating to autonomous passenger vehicle 100 operation. These messages can be sent from the smartphone via the mobile APP 650. ACC 200ordingly, the mobile APP is designed with autonomous navigation software for monitoring, communicating or managing operations of the autonomous passenger vehicle 100 via passenger's interface 101(1). The method 650 then ends.

As shown FIG. 7 the control module 34 is coupled to a communication unit 32, which is an interface to communicate with a CC 200 via mobile communications, e.g., a 4G/5G base station 202. The control module 34 uses the consistency check module to verify whether the received proposed path is consistent. A consistency check may increase the trust level in the proposed path as the autonomous passenger vehicle 100 performs additional internal tests. FIG. 7 is a generic overview of the logical modules at the remotely driven autonomous passenger vehicle 100 (left), the radio interference (middle), and the control center 200 (CC 200) located somewhere else (right). The crossed arrow from the MP module to auto-box indicates that for the exceptional traffic situation the MP cannot provide a resolving route. Therefore, the CC 200 is contacted, and the received proposed route is verified/consistency checked. ACC 200ordingly, the autonomous passenger vehicle apparatus 30 communicates information related to the environmental model, video data, and ego data (e.g., geometrics of the autonomous passenger vehicle, length, width, etc.) to the network component 200. In return the apparatus 30 receives information related to the proposed path, the environmental view from the outside (network perspective of the environment of the autonomous passenger vehicle 100) and path conditions (for example, road condition (such road ice, aqua planning, height limitation, width limitations), traffic situation, etc.)

In greater detail FIG. 8 it is assumed that the network component 200 comprises a base station (BS), the CC 200 and some server/memory. As has been outlined above, in other disclosed embodiments these components might not be collocated but located at different locations. In this description the term network component 200 shall summarize these components as one functional entity although they may be implemented as multiple physical entities. The distance between CC 200 and the autonomous passenger vehicle 100 may contribute to the latency of any driving instructions before reaching the autonomous passenger vehicle and any data (video, sensor, etc.) being transmitted from the autonomous passenger vehicle to the CC 200.

The data steams provided by a remotely or tele-operated autonomous passenger vehicle may comprise radar images, LIDAR and camera data. Close by driving autonomous passenger vehicles 100 are “seeing” the same environment around them. This redundant data is occupying a considerable amount of bandwidth in the UL. For current technologies such as 4G, the UL is expected to be a bottleneck as the network was designed to support high downlink (DL) and low UL data rates. For TD it is vice versa: high UL (sensor data) and low DL (control data). Latency is also an issue here. Furthermore, each autonomous passenger vehicle 100 needs to be driven manually via remote control. This implies that many drivers and CC 200s are needed. In such a disclosed embodiment the receiving 18 of the driving instructions comprises tele-operating the autonomous passenger vehicle along the route section to overcome the exceptional traffic situation. Moreover, information related to an environmental model of the autonomous passenger vehicle may be provided to the network component in addition to the information related to the exceptional traffic situation. The information on the environmental model may allow decreasing a subsequent video data rate on the uplink High data rates usually needed in the UL for teleoperated driving may be decreased in disclosed embodiments. In disclosed embodiments information related to autonomous passenger vehicle data and video data (e.g., with reduced data rate) may be provided to the network component in addition to the information related to the exceptional traffic situation.

Each autonomous passenger vehicle may be controlled by one driver in the CC 200. Disclosed embodiments are further based on the finding that a path driven remotely by the CC 200 might be highly redundant with the path from an autonomous passenger vehicle 100 remotely driven before. At least some disclosed embodiments therefore store information related to a route information or information related to driving instructions solving an unexpected traffic situation, such that the information can be re-used later on to solve the situation for other autonomous passenger vehicles as well. In disclosed embodiments the storage or memory for storing information related to a path or a route may be any device capable of storing such information, examples are a hard drive, a flash drive, an optical storage medium, a magnetic storage medium, a solid state memory, any mass storage device, etc.

As has been described above, different options are conceivable in disclosed embodiments to determine the route section leading out of the exceptional traffic situation. For example, the CC 200 proposes a path (route section) based on the received environmental model, autonomous passenger vehicle data and video data. The proposed path is stored on a server close to the geographical location of the path and might be used by other autonomous passenger vehicles 100+ after internal verification (plausibility check).

Instead of transmitting all sensor data to the CC 200, the autonomous passenger vehicle may upload its environmental model plus some video data in some disclosed embodiments. The proposed path may be drawn (maybe just a few points) at the CC 200 or slowly driven by CC 200.

The procedure/method may be implemented as following in a further disclosed embodiment:

1. first an automated autonomous passenger vehicle 100 stops and it calls the CC 200;

2. If there is not a proposed path at local server, it gets connected with the CC 200;

3. Autonomous passenger vehicle 100 transmits the environmental model and video data to the CC 200;

4. There are multiple options for determining the proposed path or route section;

a) The CC 200 drives autonomous passenger vehicle 100 remotely and creates the proposed path (for next autonomous passenger vehicle 100 . . . . The obtaining 24 of the information related to the driving instructions comprises tele-operating the autonomous passenger vehicle out of the exceptional traffic situation. This can be also based on transmitted environmental model data.

b) autonomous passenger vehicle 100 is driving by itself based on the proposed path (drawn with UMF+video by the CC 200). In this case the receiving 18 of the driving instructions comprises receiving information on the route section from the network component 200 and the method 10 comprises automatically operating the autonomous passenger vehicle along the route section. The method 20 further comprises receiving information related to an environmental model of the autonomous passenger vehicle from the autonomous passenger vehicle 100. The obtaining 24 of the information related to the driving instructions comprises determining information related to the route section based on the information related to the environmental model of the autonomous passenger vehicle.

c) the receiving 18 of the driving instructions comprises an instruction to manually operate the autonomous passenger vehicle out of the exceptional traffic situation. The route section is determined by manually operating the autonomous passenger vehicle out of the exceptional traffic situation. The method 10 further comprises transmitting information related to the route section to the network component. From the perspective of the network component 200 the obtaining 24 of the information related to the driving instructions comprises instructing a user of the autonomous passenger vehicle to manually operate the autonomous passenger vehicle 100 out of the exceptional traffic situation;

5. In all cases the proposed/determined path is stored or updated at a server close to the location of the path/route selection. Hence, the method 20 at the network component 200 further comprises storing information related to the route section in a storage/memory. The obtaining 24 of method 20 of the information related to the driving instructions may comprise retrieving previously stored information related to the route section from the storage/memory. The method 20 further comprises storing information related to the route section in a storage/memory;

6. Autonomous passenger vehicle 100 left the area and now autonomous passenger vehicle 100 is located at the old position of autonomous passenger vehicle 100;

7. The second autonomous passenger vehicle 100 (autonomous passenger vehicle 100) is also calling the CC 200 but is connected with the server as there is a proposed path. Autonomous passenger vehicle 100 gets the proposed path from the server; then 8. begins

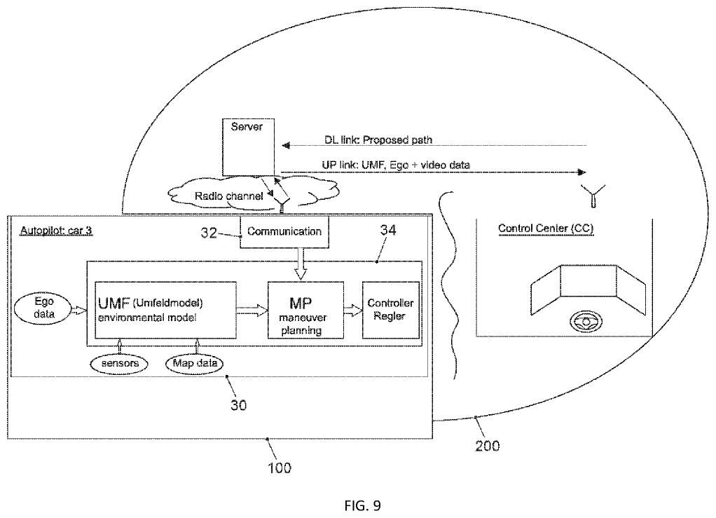

In greater detail FIG. 9 shows a model of the autopilot plus new input from the communication in a disclosed embodiment. FIG. 9 illustrates disclosed embodiments of an autonomous passenger vehicle 100 and a network component 200. Autonomous passenger vehicle 100 (in FIG. 7) is used as an example. As shown in FIG. 9 the apparatus 30 for the autonomous passenger vehicle 100 comprises a control module 34, which generates the UMF, carries out maneuver planning and controls/steers the transportation vehicle. The control module 34 receives different input data, e.g., ego data (from the transportation vehicle, e.g., engine data, brake data, tire data, component data), sensor data (radar, lidar, video), map data, etc. The apparatus 30 further comprises one or more interfaces 32, which are configured to wirelessly communicate with a network component 200 in the present disclosed embodiment. The network component 200 may be implemented in a distributed way and it may comprise a base station, a server, and a CC 200. In the present is the autonomous passenger vehicle 100 is receiving the proposed path (route section overcoming the unexpected traffic situation) from the server as part of the network component 200. The maneuver planning (MP) in the control module 34 of the autonomous passenger vehicle 100 needs to compare the proposed path with its own conditions. It either uses the proposed path or may reject it and gets connected with the CC 200 in this disclosed embodiment.

The autonomous passenger vehicle 100 gets a proposed path, this means it can accept it after internal evaluation or it might reject it. The CC 200 draws this path based on the environmental model and the video data (slim uplink) or creates it when driving the path with the first car 100 remotely.

For example, autonomous passenger vehicle 100 may provide the following content or conditions to the network component 200:
geographical position of path
distance from path to obstacles (width of the new lane)
time stamp
further environmental information

Disclosed embodiments may enable a slim uplink, i.e., reduced uplink data for remote or tele-operated driving. This may be achieved by transmitting the environmental model (UMF), transportation vehicle data (e.g., height, width, weight, . . . ) and video data in the uplink instead of transmitting more data like radar, lidar and other sensor data. In disclosed embodiments a tele-operated driving server (TD server) may be used, and the CC 200 may store a proposed path. The server may be located close to the geographical position of the proposed path to reduce latency. The TD server could also be located at a car or in infrastructure like traffic lights and shared via side-link.

In greater detail FIG. 10 shows another exceptional traffic scenario in a disclosed embodiment. FIG. 6 shows a highway scenario with a construction site 500. Vehicle hV1 (highway transportation vehicle 1) 100 has determined a path around the obstacle 500, which is locally stored at the network component 200 (e.g., base station, local server, road side unit, CC 200, etc.). For example, the stored path has been determined by tele-operated driving or manually driving the autonomous passenger vehicle 100 through the construction side 500. The following transportation vehicles hV2, hV3 can then use the proposed stored path. Disclosed embodiments may provide an efficient concept for guiding a plurality of transportation vehicles around an obstacle 500 by re-using a path determined by a first autonomous passenger vehicle 100 for other transportation vehicles subsequently passing the same obstacle 500.

In the disclosed embodiment illustrated by FIG. 10 the automated transportation vehicle 100 had troubles to drive through the construction site 500. Therefore, it was helped by the control center (CC 200) 200 via remote control. The driven path and more collected data (sensor data) from hV1 100 are sent via the radio channel and stored locally at a server at BS/RSU 200 in form of a proposed path. hV2 and hV3 101, 102 are approaching this area and may use the proposed path from the server. When/if they can use this proposed path, they do not need to call the CC 200 and tele-operated driving becomes scalable for more users. The locally stored proposed path may be stored in server/memory. Storing locally the proposed path may solve a scalability problem and reduce communication traffic. If more cars need to be driven through this critical area just the first one is controlled by the CC 200 and the following may use the locally stored proposed path. It may be stored at the BS, RSU or even at another transportation vehicle and shared via side-link. In the later scenario the network component 200 can be multiple autonomous passenger vehicles 100 . . . , sharing the information on the route section with other transportation vehicles 101, 102 via direct communication, e.g., PC5 or 3GPP side-link.

Other communications in which the acquisition network of an autonomous passenger vehicle may involve transmitting a command that controls at least one function of the autonomous passenger vehicle based on the received telematics service selection from the smartphone 602 or provide other relevant commands related to autonomous control network plans.

Other communications in which the acquisition network of an autonomous passenger vehicle may involve the control network involving controlling a current position of the autonomous passenger vehicle based on receiving information corresponding to at least one passenger's-selected starting location and a passenger's-selected destination location.

Other communications may involve the control network involving determining GPS routes for an available autonomous passenger vehicle to pick-up a passenger based on the scheduling information and to drop-off a passenger at a location determined by GPS.

Other communications may involve the control network involving one of: renting an autonomous passenger vehicles to transport a passenger or renting an autonomous passenger vehicle for picking up a delivery payload; identify available autonomous passenger vehicles to transport passenger's, determine routes for the available autonomous passenger vehicles to travel, the routes including delivery stops and being determined based on the scheduling information; receiving information corresponding to at least one virtual operator-selected starting location and a destination location.

Other communications may involve the control network which may a processor for one of the following actions: determine GPS routes for an available autonomous passenger vehicle to pick-up a passenger's based on the scheduling information then, to drop-off passenger's at a location determined by GPS routes; or determine the GPS routes by determining at least one route that includes the specific pickup location and the specific drop-off location corresponding to the premium travel request; or generate a GPS route for the autonomous passenger vehicle or to predict a route based on prior routes taken by the autonomous passenger vehicle.

Other communications in which the control network plan for renting an autonomous passenger vehicle may involve one of: receive scheduling information corresponding to at least one travel request and including a user-selected starting location and a user-selected destination location; provide memory configured to store map information including road information and preselected pick-up stops; receive information corresponding to at least one virtual operator-selected starting location and a destination location, and a processor coupled to the network access device configured to store information virtually; receive public transportation schedules, or the memory is further configured to store the public transportation schedules, to transmit the identified regions to corresponding autonomous passenger vehicles that are available nearest to the pick-up stop; receive traffic data corresponding to vehicle traffic or human traffic at various locations; identify the routes for the available autonomous passenger vehicles to travel based on the public transportation schedules.

Other communications in which the control network plan may involve one of: receive scheduling information corresponding to a location requesting to pick-up delivery order; confirm a user-selected starting location established to pick-up order then, delivery the order to a user-selected destination location; delivering the payload to a user-selected destination location or to a recipient, whereby the payload is stored in a container, basket, saddlebags, or other storage compartment; provide memory configured to store map information including road information and preselected pick-up stops.

Other communications in which the control network plan may involve one of renting an autonomous passenger vehicle for delivering a payload to a user-selected starting location established to pick-up order.

Other communications use a control module to control the one or more interfaces, wherein the control module is configured to control the apparatus to determine an exceptional traffic situation based on an environmental model for the autonomous passenger vehicle 100, transmit information related to the exceptional traffic situation to a network component using a mobile communication system, receive information related to a proposed route from a network component; and verifies the proposed route based on the environmental model of the autonomous passenger vehicle 100, wherein the verification includes performance of a consistency check on the proposed route based on the environmental model.

Other communications use a control module configured to control the one or more interfaces, wherein the control module is further configured to determine a route section for use in operating the autonomous passenger vehicle in autonomous driving to avoid an exceptional traffic situation, wherein the control module is configured to determine the exceptional traffic situation, transmit information related to the exceptional traffic situation to a network component using a mobile communication system, and receive information related to driving instructions for the route section to overcome the exceptional traffic situation from the network component, wherein the received information related to driving instructions comprises an instruction to operate the autonomous passenger vehicle 100 out of the exceptional traffic situation, whereby the route section is determined based on the manual operation of the autonomous passenger vehicle 100 out of the exceptional traffic situation, and, thereafter, information related to the route section determined based on the manual operation of the autonomous passenger vehicle 100 is transmitted to the network component.

Other communications use a control module configured to determine a route section by operating the autonomous passenger vehicle 100 in an automated driving mode, determining an exceptional traffic situation, transmitting information related to the exceptional traffic situation to a network component via a mobile communication system; and receiving, from the network component, information related to driving instructions for the route section to overcome the exceptional traffic situation, wherein the receiving of the driving instructions comprises tele-operating the autonomous passenger vehicle 100 along the route section to overcome the exceptional traffic situation, wherein, during a first period of fully tele-operating, video data is transmitted with a first higher data rate and wherein, during a second period of partially tele-operating, video data is transmitted with a second lower data rate.

It is to be understood that the foregoing is a description of one or more preferred exemplary embodiments of the invention. The invention is not limited to the particular embodiments disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiments will become apparent to those skilled in the art. All such other embodiments, changes, and modifications are intended to come within the scope of the appended claims.

I claim:

1. An autonomous passenger vehicle system comprising:
an autonomous vehicle having a frame configured with a wheel-set operably connected with a power source, seating, doors; a processing unit including a memory unit; a controller operable to receive and transmit signals to said processing unit, wherein said controller is operable to control said wheel-set; a wireless communication system electrically connected with said processing unit; a global positioning satellite receiver electrically connected with said processing unit; a first perception sensor electrically connected with said processing unit, wherein said first perception sensor is operable to detect environmental features; and a second perception sensor electrically connected with said processing unit, wherein said second perception sensor is operable to detect a feature of a one or more passengers; wherein said processing unit is operable to navigate an environment according to a plan, the controller utilizing signals from said global positioning satellite receiver; and wherein said processing unit is operable to navigate said environment utilizing signals from said first and second perception sensors in a GPS environment.

2. The autonomous passenger vehicle system according to claim 1, wherein said first perception sensor is one of a depth camera, an inertial measurement unit, a light detection and ranging unit, a radar, an ultrasonic unit, and an odometry unit.

3. The autonomous passenger vehicle system according to claim 1, wherein said second perception sensor is one of a depth camera, an inertial measurement unit, a light detection and ranging unit, a radar, an ultrasonic unit, and an odometry unit.

4. The autonomous passenger vehicle system according to claim 1, wherein said environment comprises a pick-up location and said environmental features comprise a passenger to pick up.

5. The autonomous passenger vehicle system according to claim 1, further comprising a one or more passengers, wherein said first and second perception sensors communicate information concerning a distance between said one or more passengers to said processing unit, and wherein said processing unit is operable to provide signals to said controller for sensing said one or more passengers.

6. The autonomous passenger vehicle system according to claim 1, further comprising one or more interfaces configured to communicate in a mobile communication system; and
a control module configured to control the one or more interfaces, wherein the control module is further configured to determine a route section for use in operating the autonomous passenger vehicle in an automated driving mode to avoid an exceptional traffic situation, wherein the control module is configured to determine the exceptional traffic situation, transmit information related to the exceptional traffic situation to a network component using a mobile communication system, and receive information related to driving instructions for the route section to overcome the exceptional traffic situation from the network component,
wherein the received information related to driving instructions comprises an instruction to driver remotely drives the autonomous passenger vehicle through a traffic situation, whereby the route section is determined based on an autonomous operation of the autonomous passenger vehicle to drive to a pick-up location, and thereafter drive to a drop-off location;
information related to the route section determined based on the driver operation of the autonomous passenger vehicle is transmitted to the network component.

7. The autonomous passenger vehicle system of claim 1, wherein the information related to driving instructions further comprises tele-operating the autonomous passenger vehicle along the route section to overcome the exceptional traffic situation.

8. The autonomous passenger vehicle system of claim 1, wherein the information related to driving instructions further comprises information on the route section from the network component and wherein the method comprises automatically operating the autonomous passenger vehicle along the route section.

9. The autonomous passenger vehicle system of claim 1, wherein information related to an environmental model of the autonomous passenger vehicle is received by the apparatus in addition to the information related to the exceptional traffic situation.

10. The autonomous passenger vehicle system of claim 1, wherein information related to autonomous passenger vehicle data and video data is transmitted to the network component in addition to the information related to the exceptional traffic situation.

11. An autonomous passenger vehicle system comprising:
a network component, the apparatus comprising:
one or more interfaces configured to communicate in a mobile communication system; and
a control module configured to control the one or more interfaces, wherein the control module is further configured to enable the network component to determine a route section for an autonomous passenger vehicle to overcome an exceptional traffic situation,
wherein the control module receives information related to the exceptional traffic situation from the autonomous passenger vehicle using the mobile communication system, obtains information related to driving instructions for the route section to overcome the exceptional traffic situation, and transmits information related to the driving instructions for the route section to overcome the exceptional traffic situation to the autonomous passenger vehicle, and
wherein the driving instructions comprise instructions for a one or more passengers of the autonomous passenger vehicle to 200 driver operate the autonomous passenger vehicle out of the exceptional traffic situation, wherein information related to the route section is stored in a storage by the apparatus.

12. The autonomous passenger vehicle system according to claim 11, wherein the information related to the driving instructions comprises retrieved previously stored information related to the route section from storage.

13. The autonomous passenger vehicle system according to claim 11, wherein the information related to the driving instructions comprises tele-operating the autonomous passenger vehicle out of the exceptional traffic situation, and/or wherein the method further comprises receiving information related to an environmental model of the autonomous passenger vehicle from the autonomous passenger vehicle, and wherein the obtaining of the information related to the driving instructions comprises determining information related to the route section based on the information related to the environmental model of the autonomous passenger vehicle, wherein the method further comprises storing information related to the route section in a storage.

14. The autonomous passenger vehicle system according to claim 1 and claim 11 further comprising:
operating the autonomous passenger vehicle in an automated driving mode;
determining an exceptional traffic situation;
transmitting information related to the exceptional traffic situation to a network component using a mobile communication system; and
receiving information related to driving instructions for the route section to overcome the exceptional traffic situation from the network component,
wherein the received information related to driving instructions comprises an instruction to driver remotely operating the autonomous passenger vehicle out of the exceptional traffic situation, whereby the route section is determined based on the 200 driver operation of the autonomous passenger vehicle out of the exceptional traffic situation, and, thereafter, the method further comprises transmitting information related to the route section determined based on the driver operation of the autonomous passenger vehicle to the network component.

15. The autonomous passenger vehicle system according to claim 1 and claim 11, wherein the information related to driving instructions further comprises tele-operating the autonomous passenger vehicle along the route section to overcome the exceptional traffic situation.

16. The autonomous passenger vehicle system according to claim 1 and claim 11, wherein the information related to driving instructions further comprises information on the route section from the network component and wherein the method comprises automatically operating the autonomous passenger vehicle along the route section.

17. The autonomous passenger vehicle system according to claim 1 and claim 11 further comprising:
providing information related to an environmental model of the autonomous passenger vehicle in addition to the information related to the exceptional traffic situation;
providing information related to autonomous passenger vehicle data and video data to the network component in addition to the information related to the exceptional traffic situation;
determining a route section for an autonomous passenger vehicle, the method comprising:
receiving information related to an exceptional traffic situation from the autonomous passenger vehicle using a mobile communication system;
obtaining information related to driving instructions for the route section to overcome the exceptional traffic situation; and
transmitting information related to the driving instructions for the route section to overcome the exceptional traffic situation to the autonomous passenger vehicle,
wherein the driving instructions comprise instructions for a one or more passengers of the autonomous passenger vehicle to 200 driver operate the autonomous passenger vehicle out of the exceptional traffic situation;
retrieving previously stored information related to the route section from a storage.

18. The autonomous passenger vehicle system according to claim 1 and claim 11 further comprising:
obtaining of the information related to the driving instructions comprises tele-operating the autonomous passenger vehicle out of the exceptional traffic situation, and/or wherein the method further comprises receiving information related to an environmental model of the autonomous passenger vehicle from the autonomous passenger vehicle, and wherein the obtaining of the information related to the driving instructions comprises determining information related to the route section based on the information related to the environmental model of the autonomous passenger vehicle, wherein the method further comprises storing information related to the route section in a storage.

19. An autonomous passenger vehicle system comprising:
a computer program having a program code for performing a method for the autonomous passenger vehicle to determine a route section when the computer program is executed on a computer, a processor, or a programmable hardware component, the method comprising:
operating the autonomous passenger vehicle in an automated driving mode;
determining an exceptional traffic situation;
transmitting information related to the exceptional traffic situation to a network component using a mobile communication system; and
receiving information related to driving instructions for the route section to overcome the exceptional traffic situation from the network component,
wherein the received information related to driving instructions comprises an instruction to driver operating the autonomous passenger vehicle out of the exceptional traffic situation, whereby the route section is determined based on the driver operation of the autonomous passenger vehicle to drive out of the exceptional traffic situation, and, thereafter, the method further comprises transmitting information related to the route section determined based on the driver operation of the autonomous passenger vehicle to the network component.

20. The autonomous passenger vehicle system according to claim 1, claim 11 and claim 19 further comprising:
a computer program having a program code for performing a method for a network component to determine a route section for an autonomous passenger vehicle when the computer program is executed on a computer, a processor, or a programmable hardware component, the method comprising:
receiving information related to an exceptional traffic situation from the autonomous passenger vehicle using a mobile communication system;
obtaining information related to driving instructions for the route section to overcome the exceptional traffic situation; and
transmitting information related to the driving instructions for the route section to overcome the exceptional traffic situation to the autonomous passenger vehicle,
wherein the driving instructions comprise instructions for a one or more passengers of the autonomous passenger vehicle to a 200 driver operating the autonomous passenger vehicle out of the exceptional traffic situation, and
wherein the method further comprises storing information related to the route section in a storage.
